(19) United States
(12) Patent Application Publication
(10) Pub. No.: US 2026/0300074 A1
(43) Pub. Date: Oct. 1, 2026

(54) COMPUTER ENVIRONMENT ISSUE IDENTIFICATION

(71) Applicant: Oracle International Corporation, Redwood Shores, CA (US)

(72) Inventors: Venkatesh Hiware, Atlanta, GA (US); Adam Fletcher, Derby (GB)

(21) Appl. No.: 19/097,020

(22) Filed: Apr. 1, 2025

(51) Int. Cl. G06F 11/07

(52) U.S. Cl. CPC G06F 11/079

(57) ABSTRACT

Data about a plurality of incidents of a particular type in a computer environment can be stored. Each set of feature values of a plurality of sets of feature values for each incident corresponds to a different time period of a plurality of time periods. For each set of feature values, a composite value can be generated based on the set of feature values and the composite value is added to a set of composite values. A machine-learned model can generate predicted sets of aggregated values based on the set of composite values and based on different time period lengths. An aggregated set of values can be generated based on the predicted sets of aggregated values. An operation can identify and address issues based on the aggregated set of values.

### FIELD

The present invention relates to computer environments and, more specifically, to computer environment issue identification.

### BACKGROUND

The cloud world is changing at a rapid pace, especially with multi-cloud integration that operates on a huge scale. For example, a single autonomous Relational Database Management System (RDBMS) can cover numerous regions and include hundreds of thousands of databases, and the infrastructure is predicted to double in the near future. The rapid growth of the cloud world will result in a corresponding rapid growth of incidents to correct issues that disrupt the normal operations of the cloud world and other systems. Systems, such as a RDBMS, already generate millions of automated and user-generated incident tickets for incidents each year. Incident management is a process used to identify, analyze, and correct the issues. The goal is to restore normal service as quickly as possible and minimize the impact on system operation.

Incidents can be resolved using Standard Operating Procedures (SOP), such as runbooks. However, data points for incidents are not properly tracked and correlated to determine the success of the SOP or the success of other efforts to resolve incidents. Such data points include bug impacts, incident frequency, SOP success rate, customer impact, incident lifetime, and other incident data points.

For example, Java is an application in a RDBMS, a root cause relating to Java may be unknown, and the root cause may cause a spike in bug impacts that are not being fixed by a SOP, which results in an increase in frequency of incidents, which causes a reduction in the SOP success rate. These data point attributes are not properly correlated with each other or properly correlated with incidents, which leads to a problem of increasing numbers of incidents. Also, attempts are not made to predict potential incident issues before they cause excessive damage.

As another example, a SOP for a software patch may be outdated. Running the outdated SOP creates an avalanche of problems by introducing a new bug that is not quickly fixed, so the blast impact becomes bigger because the patch has gone global. A small number of customers may initially get affected, and the problem may not be noticed until hundreds or thousands of customers are affected, which results in an escalating number of incidents, causing the incident management system to become overloaded. With the escalating scale of incidents, incidents will not be efficiently resolved without efficient data point collection and correlation.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 is an illustration of an incident management system called Catalogue Analyze List Fix (CALF) according to an example embodiment.

FIG. 2 is an illustration of an Incident Boundary (IB) system according to a possible embodiment.

FIG. 3 is an example graph of an IB line and an IB signal line according to an example embodiment.

FIG. 4 is an example illustration of a list of data for an IB according to an example embodiment.

FIG. 5 is an example graph of composite data points over a 90-day period according to an example embodiment.

FIG. 6 is an example graph of a boundary difference, an IB line, and an IB signal line according to an example embodiment.

FIG. 7 is a flowchart of a method for computer environment issue identification according to an example embodiment.

FIG. 8 illustrates a machine learning engine in accordance with one or more embodiments.

FIG. 9 illustrates the operation of a machine learning engine in one or more embodiments.

FIG. 10 is a block diagram that illustrates a computer system upon which aspects of the illustrative embodiments may be implemented.

FIG. 11 is a block diagram of a basic software system that may be employed for controlling the operation of a computer system to implement aspects of the illustrative embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Embodiments provide a system that supports the analysis, prediction, and resolution of incidents. The system can include an incident management system called CALF that monitors incident lifecycles held within the CALF vector catalogue and an IB predictive trending tool. The IB is an indicator that signifies a point where a moving average of at least one incident indicates potential future issues relating to the incident. An IB line can be formed to predict upcoming issues inside or outside of standard incident management. These issues may relate to a root cause, such as a bad or missing SOP, a problem with a software patch, or other causes. The system can assist in predicting the root cause and head off the influx of incidents, which mitigates numerous incidents that would have occurred based on the root cause, such as the bad or missing SOP.

According to a possible embodiment, a machine-learned model is placed on top of data points to predict moving average values, such as Exponential Moving Average (EMA) values, for the data points. A predicted first moving average over a first period is subtracted from a predicted second moving average over a second time period, where the first period is less than the second period. In a possible implementation, an EMA 14 value for an EMA over 14 days is subtracted from an EMA 28 value for an EMA over 28 days at particular time intervals to form an IB line, which is a momentum indicator. An IB signal line represents a predicted third moving average over a third period that is less than the first period. For example, the IB signal line is an EMA 10 value for an EMA over 10 days. The IB signal line is placed on top of the IB line and a relationship between the lines can signal potential incident issues or improvements. This signal can be used at a vector derived from the CALF catalogue or global level to signal a forward-looking predictive change in incident movement.

In a possible embodiment, data about a plurality of incidents of a particular type in a computer environment is stored. Each set of feature values of a plurality of sets of feature values for each incident corresponds to a different time period of a plurality of time periods. For each set of feature values, a composite value is generated based on the set of feature values and the composite value is added to a set of composite values. A machine-learned model generates predicted sets of aggregated values based on the set of composite values and based on different time period lengths. An aggregated set of values is generated based on the predicted sets of aggregated values. An operation identifies and addresses issues based on the aggregated set of values.

In a possible implementation of the above embodiment, a method includes storing data about a plurality of incidents of a particular type, where each of the plurality of incidents has occurred in one or more computer environments. Each of the plurality of incidents is associated with a plurality of features and a plurality of sets of feature values that correspond to the plurality of features. The features can be data points, and the feature values can be data point values. Each set of feature values of the plurality of sets of feature values corresponds to a different time period of a plurality of time periods. For each set of feature values of the plurality of sets of feature values, a composite value is generated based on the set of feature values and the composite value is added to a set of composite values which can be aggregated across a group of vectors or a single vector embedding.

The method includes inputting a set of first aggregated values into a machine-learned model to generate a predicted set of first aggregated values. The predicted set of first aggregated values is based on the set of composite values and is based on a first time period length that is longer than the length of each of the plurality of time periods. The method includes inputting a set of second aggregated values into the machine-learned model to generate a predicted set of second aggregated values. The predicted set of second aggregated values is based on the set of composite values and is based on a second time period length that is longer than the first time period length. The method includes generating an aggregated set of values based on the predicted set of first aggregated values and the predicted set of second aggregated values. The aggregated set of values can form an IB line that can act as an incident momentum indicator. The IB line allows the identification of future problems which prevents a small number of current incidents from escalating into major issues.

According to a possible implementation, the method includes inputting a set of third aggregated values into the machine-learned model to generate a predicted set of third aggregated values. The predicted set of third aggregated values is based on the set of composite values and is based on a third time period length that is longer than the length of each of the plurality of time periods and shorter than the first time period length. The set of third aggregated values can form an IB signal line. The crossing of the IB line with the IB signal line can signal future incident issues or incident improvements.

According to a possible embodiment, vector embeddings are created for different incidents. A vector catalog catalogs the incident vectors. Data point values are obtained for each vector and stored in the catalog. The data point values at particular time periods are added to form composite values. The composite values are fed into a machine-learned model that predicts future composite values. A moving average of the composite values forms the IB line, which is a convergence and divergence momentum indicator. The IB line provides predictive incident forecasting across multiple dimensions and vectors. The IB line can provide a single visual representation to forecast incident changes across multiple dimensions at a vector level.

For example, for each vector cataloged incident, a single vector composite value or a group of closely associated composite values can be analyzed for each timeframe, such as one day. Momentum indicators are put on the composite values to understand the direction of change or the impact of change in the time series data points. As a more particular example, exponential moving averages (EMAs) are placed on current data, such as today’s data, and historical data. A machine-learned model, such as an LSTM, is placed on top of the EMAs to predict future momentum using the same indicators. The outcome is a moving average momentum indicator called the IB, which indicates things are getting better or worse without misleading spikes in data, such as by showing when an IB line crosses an IB signal line on a graph.

Embodiments increase the reliability of computer systems by using the IB to predict and prevent upcoming incident issues that affect the computer systems. Upcoming incidents are caught before they cause significant disruption of the computer systems. Embodiments also provide faster resolution of incidents, which reduces the impact on users of computer systems. Embodiments also provide analysis over vectored level incidents resulting in a smaller amount of analysis covering a larger dimension of data. Embodiments further improve incident frequencies, bug impacts, customer impacts, blast impacts, incident lifetimes, SOP success rates, ticket volumes, and also provide awareness and concerns for areas of impact, reactive and proactive, forward looking and retrospectively.

Embodiments improve system performance by efficiently predicting issues and highlighting improvements. This results in improved processor operation because processors are not bogged down by the issues. This also results in improved memory storage because less memory is allocated to the issues.

### Incident Management System

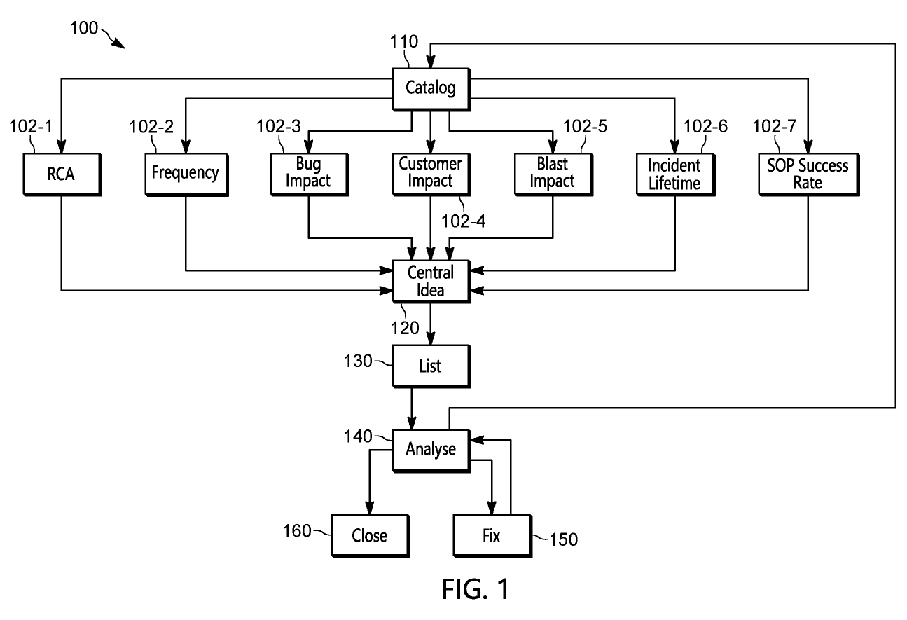

FIG. 1 is an illustration of an incident management system 100 called CALF according to an example embodiment. The incident management system 100 analyses the lifecycle of incidents for computer systems, databases, and other technical systems.

The incident management system 100 runs through various operations, such as catalog operation 110, central idea operation 120, list operation 130, analyze operation 140, fix operation 150, and close operation 160, each of which can be performed in parallel with each other. For example, list operation 130, analyze operation 140, and fix operation 150 can work together in perpetual motion until incident resolution, while the catalog operation 110 analyzes the entire process and identifies areas of impact that require attention, and the central idea operation 120 addresses these identified areas. These operations can be Artificial Intelligence (AI)-based operations. The incident management system 100 can improve SOP accuracy, improve customer impact, and provide awareness of concerns for areas of incident impact.

### Incidents

Incidents are reported for a range of issues in the incident management system 100. Incident types include service disruptions, degradation of service, security incidents, hardware failures, software errors, network issues, user errors, environmental incidents, and/or other incidents. Particular incidents can relate to Java mismatches, faulty software patches, infrastructure problems, and other causes.

In general operation, the incident management system 100 catalogs data points, such as different categories or attributes of data points 102-1 through 102-7, from vectored incident titles to create a vector catalog with at least a vector and data points for each incident. The data points 102-1 through 102-7 are collectively referred to as data points 102 and can include data points other than those shown or described. The incident management system 100 coalesces incident management data points, with other data points outside of normal data points, such as bug impact, fix rates, real customer impacts, etc., at a vector level to relate closely associated incidents. There are many incident categories, and the vectors associate incidents that are related to each other.

### Vector Embeddings

While incidents can be stored as rows in a database, the incidents can also be stored as vectors. Each incident can be represented by a vector using an embedding. The vector embeddings closely associate related incidents with each other. For example, certain incidents can be closely related application incidents, and other incidents can be closely related infrastructure incidents. Other metadata can be used for the embeddings, such as categories, titles, incident sources, natures of incidents, and other information for the embeddings. Different vectors can be used for each type of metadata, and the vectors can be embedded together, such as by using joint embeddings. The vector embedding allows for the analysis of closely related incidents. Vector embedding also allows for grouping of related incidents. While some embodiments may use vector embeddings, the vector embeddings are not required for all disclosed embodiments.

A vector is a fixed-length sequence of numbers, typically floating-point numbers, such as [21.4, 45.2, 675.34, 19.4, 83.24], which is a five-dimensional vector. An embedding is a means of representing objects (e.g., text, images, and audio) as points in a continuous vector space where the locations of those points in space are semantically meaningful to one or more machine learning (ML) algorithms. An embedding is often represented as a vector. Generically, a vector embedding represents a point in N-dimensional space. Vector embeddings are intended to capture the important "features" of the data that the vector embeddings represent (or embed). The data a vector embedding represents can be one of many types of data, such as a document, an email, an image, or a video. Examples of features are color, size, category, location, texture, meaning, and concept. Each feature is represented by one or more numbers (dimensions) in the vector embedding. Hereinafter, a “vector embedding” is referred to as a “vector.”

Today, vectors are often generated by machine-learned models (e.g., neural networks) and the features they represent are often difficult for humans to understand. One way that vectors are produced by neural networks is by capturing the outputs of the neurons in the penultimate layer, i.e., the neural network’s outputs just before the final processing layer.

An important attribute of vectors is that the distance between two vectors is a good proxy for the similarity of the objects represented by the vectors. Two vectors that represent similar data should be a short distance from each other in vector space. The opposite is also true: dissimilar data are represented by vectors that are far apart from each other in the vector space. For example, the distance between a vector for the word "cat" and a vector for the word "dog" should be less than the distance between the vector for the word "cat" and a vector for the word "plant."

The distance between two vectors is often calculated by summing the squares of the difference between the numbers in each position of the vectors:
(Vector1[1]– Vector2[1])^2 + (Vector1[2] – Vector2[2])^2 + …

The property that vector distance represents object similarity is what allows similar data to be found using a vector database. For example, when a vector representing a picture of a dog is searched for in a vector database, the nearest vectors will be those representing other dogs, not vectors representing plants.

### Catalog Operation

The catalog operation 110 analyzes incidents, provides data points and corresponding values for incidents, performs AI analysis, and/or performs other catalog operations. For example, a catalog can include incidents and data points corresponding to each incident over different time periods. In a possible embodiment, the catalog is vectored across an incident title and the catalog includes data points that correspond to each vectored incident title.

For example, when an incident comes in, it has or is given an incident title, such as “mismatched Java.”. The mismatched Java can be cataloged as a vector embedding. Closely associated vectors, such as a vector for “mismatched data patch,” are used by catalog operation 110 for analysis.

Data point values are recorded for each incident that comes in. The incident management system 100 can analyze the data point values at a vector level. The vector analysis and resolution can be performed on a particular incident type. Closely related incidents are identified by their vector proximity to the particular incident type to ascertain whether the related incidents are affected and can be similarly resolved.

### Data Points

Incident data refers to the information collected and used during the process of identifying, analyzing, and resolving incidents. Incident data can include incident details, such as description, type, severity, and status of the incident. The incident data can include time stamps, such as when the incident was reported, acknowledged, and resolved. The incident data can include affected systems or services, such as information about the systems, applications, or services impacted by the incident. The incident data can include Root Cause Analysis (RCA), such as details about the underlying cause of the incident. For example, faulty software patches, human errors, or infrastructure problems can be the root causes of an incident. The root cause may also be unknown. The incident data can include resolution steps, such as actions taken to resolve the incident and restore normal operations. The incident data can also include impact assessment, such as evaluation of the incident's impact on business operations, customers, and other stakeholders. The incident data can further include communication logs, such as records of communications related to the incident, including notifications and updates.

Incident data points 102 can include incident RCA 102-1, incident frequency 102-2, incident bug impact 102-3, incident customer impact 102-4, incident blast impacts 102-5, incident lifetime 102-6, incident SOP success rate 102-7, and/or other incident data points. Incident frequency reflects how many times a particular incident occurred over a particular time period. Bug impact can reflect internal bugs that are created in an RDBMS. Customer impact and blast impact can be external impacts of an incident, where blast impact reflects how many geographic regions are affected. SOP success rate reflects the success of standard fixes that are implemented. The data points 102 and corresponding values are stored for incident vectors in a vector catalog.

The data points 102 can be used as features in a machine-learned model, where features are measurable properties or characteristics of the data being used. The data points 102 are used for analysis, such as using Recurrent Neural Networks (RNNs), Large Language Models (LLMs), raw analysis, and other analysis. For example, the catalog operation 110 can register text and other information about an incident as a vector embedding with a related text key. The collected data points 102 can then be used by various other operations, such as automated incident resolution, interrogated using LLM/raw queries, fed into machine-learned algorithms, and/or used by other operations, examples of which are described later in this disclosure. Machine-learned algorithms can include predictive algorithms, such as Long Short-Term Memory (LSTM) algorithms, RNN algorithms, and other algorithms.

### Central Idea

The central idea operation 120 identifies causes, improvements, and/or solutions, and provides other suggestions for incident resolution. The central idea operation 120 can use incident data points and other information to identify and address issues, such as by changing a SOP for a particular incident. For example, the central idea operation 120 can determine solutions, such as a patching cycle needs to be changed, heavy migrations need to be slowed down, traffic needs to be distributed differently across different regions, and other possible solutions.

The IB analysis described below can trigger the central idea operation 120. The IB analysis can also indicate whether a particular central idea had a positive or negative impact.

### Other Operations

The list operation 130 lists incidents in a queue, provides searching for specific ticket titles, provides searching for specific comments within tickets, provides vector search groups of tickets that fit a specific pattern, provides count equivalents that can be issued for each list command, employs AI vector search techniques, and/or can provide other list operations. The analyze operation 140 runs an analysis using automatic diagnostics. The analyze operation 140 checks an alarm status of tickets, runs related metrics for tickets, checks comments for issues, runs code to analyze issues, relates tickets to bugs, bulk/single updates ticket with related information, provides a suggestion as to what to do with a ticket, collates and packages analyses, updates tickets, and/or performs other analyze operations. The fix operation 150 runs SOP fixes for issues, scores score SOP success rates, updates statuses of fix successes, raises changes, closes tickets, re-runs and performs fix analysis, and performs other fix operations. The close operation 160 closes tickets and issues after they are fixed. If a ticket is stuck and cannot be closed at the close operation 160, the analyze operation 140 can invoke the central idea operation 120. The illustrated operations can be automated, implemented by a user, accessed by other operations, and/or otherwise implemented.

### Incident Boundary System

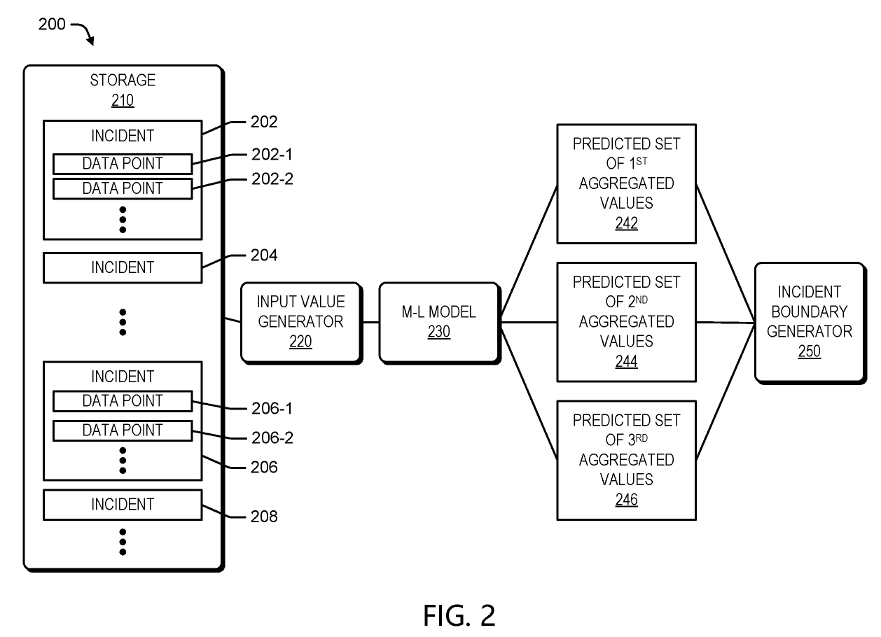

FIG. 2 is an illustration of an IB system 200 according to a possible embodiment. The IB system 200 includes storage 210, input value generator 220, a machine-learned model 230, predicted sets of aggregated values 242, 244, and 246, and incident boundary generator 250. The IB system 200 collects and analyzes incident trends and data points and operates in parallel with the incident management system 100.

The storage 210 stores data about different incidents 202, 204, 206, 208. Different incidents can be of different types. For example, incidents 202 and 204 can be of a first incident type and incidents 206 and 208 can be of another incident type. Each incident can include various data points 202-1, 202-2, 206-1, 206-2, etc.

### Input Value Generator

Input value generator 220 can generate composite values of data points. Each composite value can be a sum of values of each different data point. For example, the composite value can be the sum of a frequency data point value, a bug impact data point value, a customer impact value, a blast impact data point value, and other data point values.

Each composite value can correspond to a particular time period, such as a particular day, week, month or year, or other time interval. Thus, multiple composite values can be generated, where each composite value corresponds to a particular time period. For example, a rollup of data can be performed at the end of the day for each data point, such as frequency, bug impact, customer impact, etc. The composite value for a particular day is the sum of the rolled-up values for each data point for that particular day.

Because lower values typically reflect better values for some data points such as frequency, bug impact, etc., and a higher value typically reflects a better value for SOP success rate, the SOP success can be inverted, such as to reflect an SOP failure rate, for consistency when generating the composite value. In a possible implementation, different data points can be given different weights when generating the composite value.

An RCA data point may not have a quantifiable value and may not be included in the composite value. For example, the RCA can relate to a patch, a change, or an infrastructure failure. In an implementation, the RCA can be used as an embedding to categorize incidents and embeddings can be joined for grouping incidents. Also, instead of including the RCA in the composite values, the RCA data point can be used for filtering analysis, data, and results based on a particular RCA.

In a possible implementation, input value generator 220 generates sets of aggregated values based on moving averages of the composite values. For example, input value generator 220 generates a set of first aggregated values based on a first moving average of the set of composite values over a first time period length, generates a set of second aggregated values based on a second moving average of the set of composite values over a second time period length, and generates a set of third aggregated values based on a second moving average of the set of composite values over a third time period length.

In an example, a plurality of time periods each have a length of one day. Each time period in a plurality of time periods corresponds to a particular day. Each composite value is based on summing the value for each data point for each particular day. The length of the first time period is longer than the length of each of the plurality of time periods. For example, the first time period length is 14 days and the length of each of the plurality of time periods is one (1) day. The second time period length is longer than the first time period length. In this example, the second time period length is 28 days. The third time period length is longer than the length of each of the plurality of time periods and shorter than the first time period length. In this example, the third time period length is 10 days.

### Machine-Learned Model

The machine-learned model 230 is trained on historical data over an extended period and is used to predict where the incident management system 100 is heading based on numeric values for the data points. In different embodiments, the data points can be fed as raw data point values, can be fed as composite values, can be fed as sets of aggregated values, and/or can be otherwise fed as feature values into the machine-learned model 230. The machine-learned model 230 can be an RNN, a supervised LSTM, or any other machine-learned model. For example, an LSTM is a type of RNN that uses Artificial Neural Networks (ANN). The LSTM is designed to handle long-term dependencies and sequential data, such as time series data. The LSTM learns from sequences of data. This can involve feeding the sequential data into the LSTM, which processes the data step-by-step, maintaining a memory of previous steps to make predictions or classifications based on the entire sequence.

Time series data is a sequence of data points collected or recorded at specific time intervals. This type of data is used to track changes over time. One characteristic of time series data is temporal order, where the data points are ordered chronologically. Another characteristic of time series data is regular intervals, where data is typically collected at consistent time intervals, such as hourly, daily, monthly, etc. Another characteristic of time series data is trend analysis, where time series data is used to identify trends, patterns, and seasonal variations over time. Time series analysis involves techniques to model and predict future values based on historical data, which can be useful for forecasting and decision-making.

The machine-learned model 230 analyses the vector cataloged lifecycle of incidents. The machine-learned model 230 can run a supervised algorithm, which predicts and holds a view of each dimension of data points. The use of the machine-learned model 230 on the data points adds a predictive aspect to incident resolution. For example, a prediction can be made of where a new SOP will be required from the trending data taken from the machine-learned model forecast and work can be performed on the new SOP proactively rather than reactively.

The machine-learned model 230 generates predicted sets of aggregated values 242, 244, and 246. For example, once the machine-learned model 230 has been created, such as defined and initialized, it is placed on top of the data points to generate the predicted sets of aggregated values 242, 244, and 246. Each different predicted set of aggregated values 242, 244, and 246 correspond to different time period lengths, such as the first, second, and third time period lengths.

Two moving averages of the predicted sets of aggregated values can be used as a divergence indicator. For example, the moving averages can be plotted as lines on a graph where one line represents an IB line and one line represents an IB signal line, where both lines are based on predicted moving averages. A downwards divergence of the IB line from the IB signal line suggests a predicted good change in the data points, and an upwards divergence of the IB line from the IB signal line suggests a predicted bad change in the data points. In response to the divergence of the IB and IB signal lines, further analysis can be performed to determine what is responsible for, or is going to be responsible for, the divergence. For example, a SOP may have been implemented that initially had a 99% success rate for Java mismatches. The predicted IB line crossing of the IB signal line can provide a flag for analysis, and the analysis can ascertain that the SOP now has or is trending towards a 20% success rate.

In the example discussed above, a plurality of time periods each have a length of one day. Each time period in a plurality of time periods corresponds to a particular day. Each composite value is based on summing the data points for each category for each particular day. The predicted set of first aggregated values 242 is based on the set of composite values and is based on the first time period length that is longer than the length of each of the plurality of time periods. In this example, the first time period length is 14 days and the length of each of the plurality of time periods is one day. The predicted set of second aggregated values 244 is based on the set of composite values and is based on the second time period length, which is longer than the first time period length. In this example, the second time period length is 28 days. The predicted set of third aggregated values 246 is based on the set of composite values and is based on a third time period length that is longer than the length of each of the plurality of time periods and shorter than the first time period length. In this example, the third time period length is 10 days.

In a more specific example implementation, the machine-learned model 230 generates EMAs, such as the EMA 10, the EMA 14, and the EMA 28 for the predicted sets of aggregated values. The EMA 10 is the EMA calculated over 10 periods, the EMA 14 is the EMA calculated over 14 periods, and the EMA 28 is the EMA over 28 periods. Shorter periods react faster than longer periods. Thus, the EMA 14 reacts more quickly than EMA 28. Current data point values, current EMAs, and/or other current data can be used as input features to help the machine-learned model 230 predict future EMAs, trends, and/or other information.

### Incident Boundary Generator

The IB generator 250 generates an aggregated set of values that is based on the predicted set of first aggregated values 242 and the predicted set of second aggregated values 244. For example, the IB generator 250 subtracts a moving average of the predicted set of second aggregated values from a moving average of the predicted set of first aggregated values to generate the aggregated set of values. In another example, the predicted set of second aggregated values and the predicted set of first aggregated values are moving average values and the IB generator 250 subtracts the predicted set of second aggregated values from the predicted set of first aggregated values, such as by subtracting a predicted second aggregated value from a predicted first aggregated value at particular time periods, such as for particular days, to generate the aggregated set of values. In the example described above, the IB generator subtracts the predicted EMA 28 values from the predicted EMA 14 values to generate the aggregated set of values.

The IB generator 250 forms an IB line based on the aggregated set of values. For example, each value in the aggregated set of values is plotted on a graph with respect to its corresponding time period, such as the day corresponding to the value. The IB generator 250 can also form an IB signal line based on the predicted set of third aggregated values. For example, the IB signal line can be based on predicted EMA 10 values.

The IB generator 250 can continuously or semi-continuously generate the IB and IB signal lines. In a possible example, there is a daily roll up of the data point values and the IB and IB signal lines are generated on a daily basis. Various intervals, such as time period lengths, for roll ups, IB line generation, and other elements can be used, such as intervals of every minute, every number of minutes, every day, every number of days, every week, or other intervals. The IB generator 250 can project the IB and IB signal lines for a forward-looking period of time. For example, the IB generator 250 projects an IB line over 30 days from the current day for a daily roll up of data point values.

The IB and IB signal lines can be generated for different incident types and root causes, such as mismatched Java code and mismatched data patch root causes. Because each incident type can have a vector embedding, analysis performed on one incident type can be applied to related incident types by searching for similar incident vectors. For example, the IB and IB signal lines can be for a root cause of mismatched Java. A vector search can be conducted to find closely related problems, such as mismatched data patches. A solution applied to mismatched Java code can be applied to mismatched data patches because they are closely related. Also, the IB, solutions, and other information for new incident types can be matched to existing incident types based on the vector embeddings. For example, when a new AI application is added, there are no data points for the new application. However, there may be data points for problems, such as mismatched Java. A vector embedding of the AI application will closely associate problems with the AI application to problems of existing applications. This allows for identification of root causes and solutions for a problem with the new AI application with less guessing because the root causes and solutions are already known for related applications that have existing SOPs to fix the root cause.

### Incident Boundary

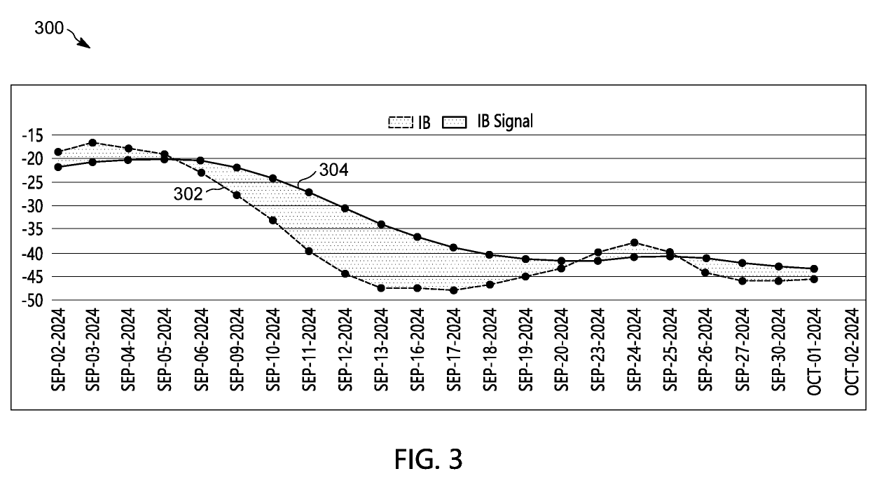

FIG. 3 is an example graph 300 of an IB line 302 and an IB signal line 304 according to an example embodiment. The X-axis of the graph 300 represents time periods as days. Other time periods can be used, such as hours, weeks, months, or other time periods. While the Y-axis of the graph 300 can be considered to represent predicted IB values, the significance of the graph 300 is reflected in the movement of the IB line 302 and the IB signal line 304 instead of particular values of the Y-axis.

The IB line 302 can correspond to a faster moving average of data points than the IB signal line 304. The combination of the IB line 302 and the IB signal line 304 form a momentum indicator, which is generically referred to as an IB. The crossing of the IB line 302 over the signal 304 indicates a divergence of the lines. For example, the IB line 302 going above the IB signal line 304 indicates a potential problem and the IB line 302 going below the IB signal line 304 indicates potential improvement. The graph 300 provides a simplified method of looking at the outcome of data points while removing spikes to show consistent divergence. For example, the consistent divergence reflects the data points moving in a consistent direction of divergence without data spikes.

In this example, the predicted EMA 14 values minus the predicted EMA 28 values (EMA 14 - EMA 28) from the machine-learned model forms the IB line 302. In particular, the result of the EMA 14 minus EMA 28 calculation is referred to as the IB line 302 that is a momentum indicator. This IB line 302 can serve as a baseline or reference point for further analysis, such as for moving average convergence and divergence momentum indication for predictive forecast signaling. For example, EMA14 > EMA28 shows an upward trend and EMA14 < EMA28 shows a downward trend.

Predicted EMA 10 values generated by the machine-learned model forms an IB signal line 304 that is placed on top of the IB line 302 to signal momentum and divergence. In particular, the predicted EMA 10 values form the IB signal line 304, which is used as an IB signal that indicates divergence between the lines 302 and 304, which indicates a potential problem or success. The crossing of the IB line 302 across the IB signal line 304 suggests a change in direction is about to occur. For example, the crossing of the IB line 302 below the IB signal line 304 on Sep. 6, 2024 can indicate a successful central idea, such as a successful new SOP, has been implemented. The crossing of the IB line 302 above the IB signal line 304 on Sep. 23, 2024 indicates a potential problem, such as a flaw with a new SOP or other potential problem.

The IB, which is based on the IB line 302 and/or the IB signal line 304, can be used at a vector, or global level, to signal a forward-looking predictive change in incident movement, such as to identify and confirm trends or signals in the data. Referring back to FIG. 1 as an example, the IB can be used by the central idea operation 120 to predict issues and generate corrections before the issues occur. In another example, the IB can be used by the list operation 130 to list upcoming issues or for a user to ask the list operation 130 about upcoming issues. For example, the incident management system 100 can employ a management interface employed by users to interact with elements of the incident management system 100. A user can ask which incidents will increase next week, what fixes should a team prepare to work on, how many customers could be affected, what bugs frequently caused regression for a particular incident vector, and other questions. The catalog 110 can be used with the IB to respond to the end user with requested results, to output an alert of upcoming issues, to proactively automate resolution of the issues, and/or to perform other operations.

### Central Idea Operation Trigger

According to a possible implementation, the IB line 302 is used as a trigger for the central idea operation 120. The central idea operation 120 can be triggered in response to the IB line 302 crossing the IB signal line 304, the IB line 302 potentially crossing the IB signal line 304, the slope of the IB line 302 becoming greater than the IB signal line 304, the slope of the IB line 302 becoming positive, and/or other information provided by the IB line 302 and/or the IB signal line 304. As alluded to above, the information provided by the IB line 302 and/or the IB signal line 304 can be generically referred to as the IB. The trigger can be in the form of automatically implementing the central idea operation 120, in the form of issuing an alert message or alarm, in the form of a user noticing a potential issue when reviewing the graph 300, or in the form of other triggers. Thus, the IB can act as a signal for the central idea operation 120. The crossing or potential crossing of the IB line 302 over the IB signal line 304 can also output an alert or trigger a process for other reasons, such as by providing an alert of upcoming issues or an indicator of a successful solution.

The central idea operation 120 can be automated, can involve human intervention, or can be semi-automated. The central idea operation 120 can analyze the data points 102 and other information tracked by the incident management system 100 to determine the cause of potential upcoming issues signaled by the IB. The central idea operation 120 can also determine solutions to issues, such as a new SOP to address an upcoming issue signaled by the IB.

For example, the SOP success rate may be deteriorating because of RCA patch issues. The deterioration of the SOP success rate is reflected in the IB line 302, such as convergence of the IB line 302 with the IB signal line 304. The issue reflected by the IB line 302 triggers the central idea operation 120, which determines that the SOP should be changed. Once the SOP is changed, the incident management system 100 and the IB system 200 continue the analysis process. Ideally, the values of data points, such as the frequency, the bug impact, the customer impact, etc., reduce as a result of the central idea operation 120. The reduction in the values from the new SOP creates a downwards trend in the IB line 302 and a resulting downwards divergence of the IB line 302 from the IB signal line 304, which indicates the central idea operation 120 was effective. As other examples, the central idea operation 120 can determine that the root cause was a software patch and the software patch procedure should be fixed, the root cause is an infrastructure issue that should be fixed, the root cause was excessive new customers overloading the system, the root cause was excessive cloud migration into shared services, and/or the root cause is any other cause. The central idea operation 120 can also generate new SOPs and other solutions to problems. The incident management system 100 continues the analysis process measuring and cataloging information, such as the data points 102, to determine the impact of the solution generated by the central idea operation 120. The IB is continuously generated to determine the impact of the change from the central idea operation 120, which ideally leads to a downwards divergence of the IB line 302 from the IB signal line 304.

Not only does the IB indicate future problems, but it also measures the success of a central idea. A good central idea pulls the IB line 302 below the IB signal line 304, such as by implementing a successful new SOP. A poor central idea pushes the IB line 302 above the IB signal line 304. For example, a central idea may have provided what appears to be an improvement. However, the particular improvement may be a short-term improvement that may actually lead to future problems. The IB can be used to signal the future problems that were caused by the particular short-term improvement. The central idea operation 120 is then invoked to address the future problems.

The IB line 302 and the IB signal line 304 are formed from composite numeric values of aggregated data points. The RCA data point 102-1 shown in FIG. 1 may or may not be used in the composite value because it may or may not have a numeric value. The RCA data point 102-1 can be used as a filter to span across other data points, such as frequency data point 102-2, the bug impact data point 102-3, etc. In a related example, the RCA data point can be used as a drop-down box to select a root cause and corresponding related data points 102-2 through 102-7 and/or to generate or select an IB for the root cause. For example, related data points can be grouped by root causes and a drop-down box for the RCA can be used to generate the graph 300 for a particular root cause or group of root causes. Alternatively, or additionally, a numerical value can be generated for the RCA data point 102-1 for inclusion with the other data points as part of the composite value.

Vector embeddings can be used with the IB to identify similar incidents that also may be affected in the future by the same or a related problem or solution. The vector embeddings can also be used to identify potential problems or solutions for incidents relating to new applications that are similar to existing applications and incidents. Vector embeddings also allow the graph 300 to be used to look at a group of related incidents and applications. For example, the graph 300 can be used to look at the five closest related Java codes or mismatches. Thus, the vector embeddings allow the IB to be used across incidents.

The catalog operation 110 can then spin a full circle on itself. Thus, for a particular embedding, analysis can be performed pre/post central idea operation 120 to compare changes that have caused improvements, degradations, etc.

### Example Incident Boundary

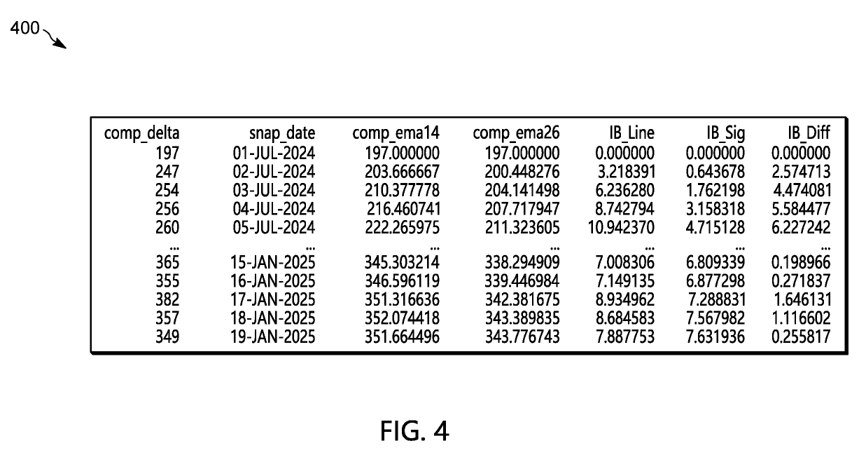

FIG. 4 is an example illustration of a list 400 of data for an IB according to an example embodiment. The list 400 includes columns for composite delta values, snapshot dates, composite EMA 14 values, composite EMA 28 values, IB line values, IB signal values, and IB difference values. The comp_delta value is the composite value aggregated over a day, where each day is a daily rollup in a time series model. The EMA 14 and an EMA 28 are placed on top of the comp_delta value to create the columns for each EMA. The IB line is created based on the EMA 14 and the EMA 28 of the comp_delta value, where the IB line is the EMA 14 minus the EMA 28. The IB signal is an EMA 9 of the comp_delta value. The IB_diff column shows the difference between IB line and IB signal.

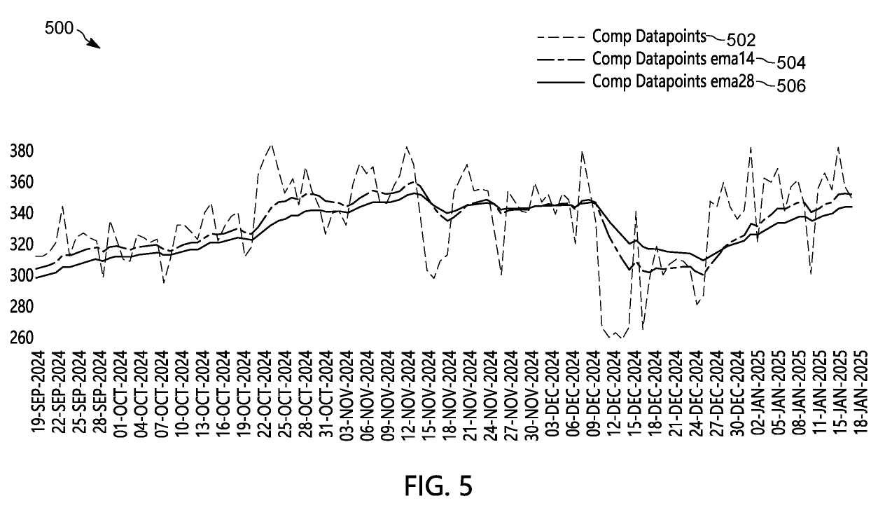

FIG. 5 is an example graph 500 of composite data points over a 90-day period according to an example embodiment. The graph 500 shows composite data points 502, the composite EMA 14 data points 504, and the composite EMA 28 data points 506. Spikes in the composite data points 502 are eradicated by using the EMAs to give a smoother picture of movement. The graph 500 shows an increasing trend starting on December 28th.

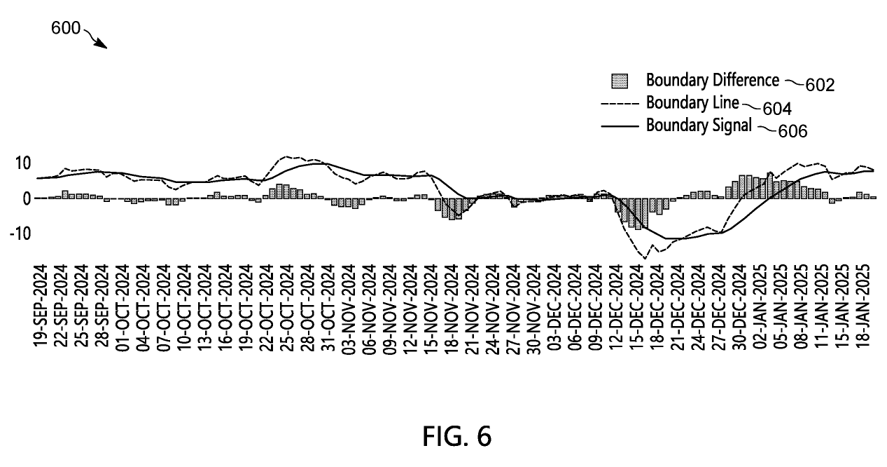

FIG. 6 is an example graph 600 of a boundary difference 602, an IB line 604, and an IB signal line 606 corresponding to the graph 500 according to an example embodiment. The IB signal line 606 can be considered a momentum indicator. The movement of the IB line 604 above the IB signal line 606 pinpoints an upwards divergence in momentum. The divergences can be used to show where things are getting worse or better for each vector in a catalog by simply looking at divergences in momentum. Upward divergence can be considered bad, and downward divergence can be considered good. In this example, the graph 600 shows a divergence where the IB line 604 crosses above the IB signal line 606. The divergence suggests an upcoming problem. The divergence reflects changes that occurred in response to the central idea 120, regardless of whether the idea was the result of human or automated changes.

### Example Methods

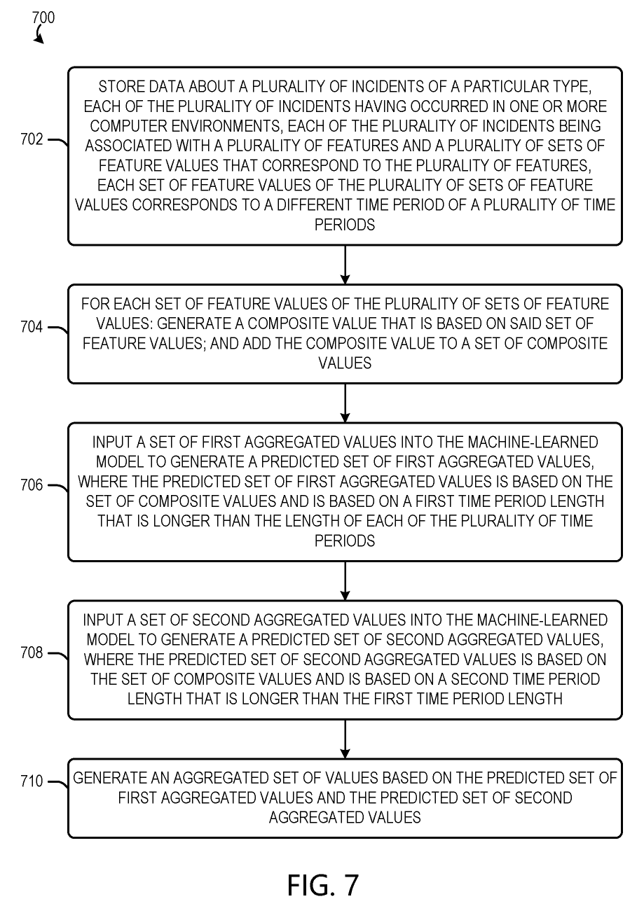

FIG. 7 is a flowchart 700 of a method for computer environment issue identification according to an example embodiment. One or more computing devices perform the method. At 702, the method includes storing data about a plurality of incidents of a particular type. Each of the plurality of incidents has occurred in one or more computer environments. Each of the plurality of incidents is associated with a plurality of features and a plurality of sets of feature values that correspond to the plurality of features. For example, the plurality of features include or are related to at least two selected from an incident frequency, an incident impact, an incident consumer impact, an incident blast impact, an incident lifetime, an incident standard operating procedure success rate, an RCA, and/or other features. The feature values can be values of data points, such as an incident frequency value, an incident lifetime value, an incident impact value, an incident SOP failure rate value, and/or other incident values for each feature. Each set of feature values of the plurality of sets of feature values corresponds to a different time period of a plurality of time periods. A set of feature values can include a value that represents each feature for a given day, week, or other time period. For example, a value for frequency can represent how often an incident occurred on a particular day, a value for blast impact can represent how big of a geographical region was affected on a particular day, etc.

At 704, the method includes for each set of feature values of the plurality of sets of feature values generating a composite value that is based on the set of feature values and adding the composite value to a set of composite values. Generating the composite value can include summing the values in the set of feature values for each set of feature values of the plurality of sets of feature values. Each value in the set of feature values corresponds to a different feature of the plurality of features. For example, each feature value for a particular day is added together to generate a composite value and the set of composite values includes a composite value for each day.

At 706, the method includes inputting a set of first aggregated values into a machine-learned model to generate a predicted set of first aggregated values. The machine-learned model can be an LSTM, an RNN, or any other machine-learned model that can generate a predicted set of aggregated values. The predicted set of first aggregated values is based on the set of composite values and is based on a first time period length that is longer than a length of each of the plurality of time periods. For example, the length of each plurality of time periods is one day and the length of the first time period is 14 days. Each first aggregated value can be an average of composite values over the first time period length of 14 days. As discussed above, other time period lengths are possible. Each predicted first aggregated value in the predicted set of first aggregated values can be a prediction of a moving average of the composite value over the first time period length at a future point in time.

At 708, the method includes inputting a set of second aggregated values into the machine-learned model to generate a predicted set of second aggregated values. The predicted set of second aggregated values is based on the set of composite values and is based on a second time period length that is longer than the first time period length. For example, the second time period length is approximately double the first time period length, such as by being 28 days when the first time period length is 14 days, but other lengths are possible, such as triple the length, 1.5 times the length, or other lengths. In an implementation, the first time period length is between 30 to 70 percent of the second time period length. If the second time period length is 28 days, each second aggregated value can be an average of composite values over the second time period length of 28 days. Each predicted second aggregated value in the predicted set of second aggregated values can be a prediction of a moving average of the composite value over the second time period length at a future point in time.

At 710, the method includes generating an aggregated set of values based on the predicted set of first aggregated values and the predicted set of second aggregated values.

According to a possible embodiment, the method includes inputting a set of third aggregated values into the machine-learned model to generate a predicted set of third aggregated values. The predicted set of third aggregated values is based on the set of composite values and is based on a third time period length that is longer than the length of each of the plurality of time periods and shorter than the first time period length. For example, the third time period length is 10 days, the length of each plurality of time periods is one day, and the first time period length is 14 days. Each third aggregated value can be an average of composite values over the first time period length of 10 days. Each predicted third aggregated value in the predicted set of third aggregated values can be a prediction of a moving average of the composite value over the third time period length at a future point in time.

According to a possible implementation of the above embodiment, the method includes determining a first slope of a first line, such as an IB line, based on the aggregated set of values. The method includes determining a second slope of a second line, such as an IB signal line, based on the predicted set of third aggregated values. The method includes identifying a particular time period where the first slope is greater than the second slope. An alert or other information can be output, an automated troubleshooting and/or resolution process can be implemented, or other actions can be performed in response to the identification of the first slope being greater than the second slope and/or in response to other relationships between the IB and the IB signal line.

According to a possible implementation of the above embodiment, the method includes identifying a particular time period where a first line, such as an IB line, representing the aggregated set of values, crosses a second line, such as an IB signal line, representing the predicted set of third aggregated values. An alert or other information can be output, an automated troubleshooting and/or resolution process can be implemented, or other actions can be performed in response to determining the first line will cross the second line.

According to a possible implementation of the above embodiment, the predicted set of third aggregated values and the aggregated set of values can be used for predictions for incidents of the second type. In particular, the method can include generating a first embedding based on text that is associated with the particular type of incident. As discussed above, an embedding is a numerical representation of an object, like text, an image, audio, etc. It represents the object in a vector space. Embeddings serve as a bridge between raw data of objects and machine learning models by converting object data into numerical form that models can process. The goal of embeddings is to capture the semantic meaning and relationships within the data in a way that similar items are closer together in the embedding space. The method can include generating a second embedding based on text that is associated with a second type of incident that is different than the particular type of incident. For example, the second type of incident can be a new incident with no history or can be another existing incident. The method can include, based on a similarity between the first embedding and the second embedding, using the predicted set of third aggregated values and the aggregated set of values in a prediction for incidents of the second type.

According to a possible embodiment, the aggregated values can be generated based on the corresponding time periods and added to the corresponding sets of aggregated values prior to inputting the sets of aggregated values into the machine-learned model. In particular, the method can include based on the set of composite values and for each time period of the plurality of time periods: prior to inputting the set of first aggregated values into the machine-learned model: generating a first aggregated value based on a first particular time period of the first time period length; and adding the first aggregated value to the set of first aggregated values; and prior to inputting the set of second aggregated values into the machine-learned model: generating a second aggregated value based on a second particular time period of the second time period length; and adding the second aggregated value to the set of second aggregated values. The method can also include, based on the set of composite values and for each time period of the plurality of time periods: prior to inputting the set of third aggregated values into the machine-learned model: generating a third aggregated value based on a third particular time period of the third time period length; and adding the third aggregated value to the set of third aggregated values.

According to a possible embodiment, the method can be repeated for a second incident type. In particular, the method can include storing data about a second plurality of incidents of a second particular type. Each of the second plurality of incidents is associated with a second plurality of features and a second plurality of sets of feature values that correspond to the second plurality of features. Each set of feature values of the second plurality of sets of feature values corresponds to a different time period of a plurality of first time periods. The method includes, for each second set of feature values of the second plurality of sets of feature values: generating a second composite value that is based on the second set of feature values; and adding the second composite value to a second set of composite values. The method includes inputting a second set of first aggregated values into the machine-learned model to generate a second predicted set of first aggregated values. The second predicted set of first aggregated values is based on the second set of composite values and is based on the first time period length. The method includes inputting a second set of second aggregated values into the machine-learned model to generate a second predicted set of second aggregated values. The second predicted set of second aggregated values is based on the second set of composite values and is based on the second time period length. The method includes generating a second aggregated set of values based on the second predicted set of first aggregated values and the second predicted set of second aggregated values.

According to a possible embodiment, the aggregated values are based on an average, such as a moving average or exponential moving average, of composite values. For example, the set of first aggregated values is based on a first moving average of the set of composite values over the first time period length. The set of second aggregated values is based on a second moving average of the set of composite values over the second time period length. The set of third aggregated values is based on a third moving average of the set of composite values over the third time period length. In a possible implementation, generating the aggregated set of values includes subtracting the second moving average of the set of composite values from the first moving average of the set of composite values.

According to a possible embodiment, for each set of feature values of the plurality of sets of feature values, generating the composite value includes summing the values in the set of feature values. Each value in the set of feature values corresponds to a different feature of the plurality of features.

### Machine Learning Engine

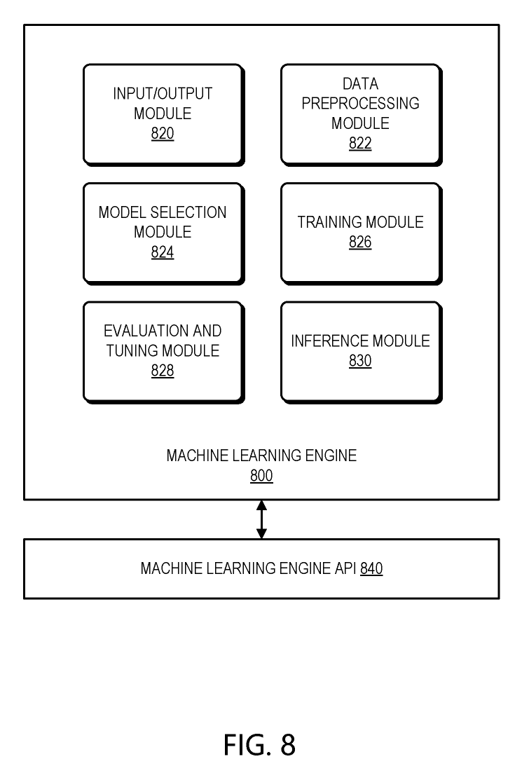

FIG. 8 illustrates a machine learning engine 800 in accordance with one or more embodiments. As illustrated in FIG. 8, machine learning engine 800 includes input/output module 820, data preprocessing module 822, model selection module 824, training module 826, evaluation and tuning module 828, and inference module 830.

In accordance with an embodiment, input/output module 820 serves as the primary interface for data entering and exiting the system, managing the flow and integrity of data. This module may accommodate a wide range of data sources and formats to facilitate integration and communication within the machine learning architecture.

In an embodiment, an input handler within input/output module 820 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 820 to be versatile in different operational contexts, whether processing historical datasets or streaming data.

In accordance with an embodiment, input/output module 820 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 820 includes an output framework designed to handle the distribution and exportation of outputs, predictions, or insights. Using the output framework, input/output module 820 formats these outputs into user-friendly and accessible formats, such as reports, visualizations, or data files compatible with other systems. Input/output module 820 also ensures secure and efficient transmission of these outputs to end-users or other systems in an embodiment and may employ encryption and secure data transfer protocols to maintain data confidentiality.

In accordance with an embodiment, data preprocessing module 822 transforms data into a format suitable for use by other modules in machine learning engine 800. For example, data preprocessing module 822 may transform raw data into a normalized or standardized format suitable for training ML models and for processing new data inputs for inference. In an embodiment, data preprocessing module 822 acts as a bridge between the raw data sources and the analytical capabilities of machine learning engine 800.

In an embodiment, data preprocessing module 822 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 822 may be configured to handle anomalies in different ways depending on context. Data preprocessing module 822 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model’s ability to learn effectively.

In an embodiment, data preprocessing module 822 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 822 processes new data for inference, data preprocessing module 822 replicates the same preprocessing steps to ensure consistency with the training data format. This helps to avoid discrepancies between the training data format and the inference data format, thereby reducing the likelihood of inaccurate or invalid model predictions.

In an embodiment, model selection module 824 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 824 employs a variety of statistical and analytical techniques to understand data patterns, identify potential correlations, and assess the complexity of the task. Based on this analysis, the model selection module 824 then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 824 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 824 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model’s accuracy. A lower MSE may indicate a model’s greater accuracy in predicting values, as it represents a smaller average discrepancy between the actual and predicted values.

In accordance with an embodiment, model selection module 824 also considers computational efficiency and resource constraints. This is meant to help ensure the selected model is both accurate and practical in terms of computational and time requirements. In an embodiment, certain features of model selection module 824 are configurable such as a configured bias toward (or against) computational efficiency.

In accordance with an embodiment, training module 826 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 826 handles the iterative process of feeding the training data into the model, adjusting the model’s internal parameters (like weights in neural networks) through backpropagation and optimization algorithms, such as stochastic gradient descent or other algorithms providing similarly useful results.

In accordance with an embodiment, training module 826 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 826 includes logic to handle different types of data and learning tasks. For instance, it includes different training routines for supervised learning (where the training data comes with labels) and unsupervised learning (without labeled data). In the case of deep learning models, training module 826 also manages the complexities of training neural networks that include initializing network weights, choosing activation functions, and setting up neural network layers.

In an embodiment, evaluation and tuning module 828 incorporates dynamic feedback mechanisms and facilitates continuous model evolution to help ensure the system’s relevance and accuracy as the data landscape changes. Evaluation and tuning module 828 conducts a detailed evaluation of a model’s performance. This process involves using statistical methods and a variety of performance metrics to analyze the model’s predictions against a validation dataset. The validation dataset, distinct from the training set, is instrumental in assessing the model’s predictive accuracy and its capacity to generalize beyond the training data. The module’s algorithms meticulously dissect the model’s output, uncovering biases, variances, and the overall effectiveness of the model in capturing the underlying patterns of the data.

In an embodiment, evaluation and tuning module 828 performs continuous model tuning by using hyperparameter optimization. Evaluation and tuning module 828 performs an exploration of the hyperparameter space using algorithms, such as grid search, random search, or more sophisticated methods like Bayesian optimization. Evaluation and tuning module 828 uses these algorithms to iteratively adjust and refine the model’s hyperparameters – settings that govern the model’s learning process but are not directly learned from the data – to enhance the model’s performance. This tuning process helps to balance the model’s complexity with its ability to generalize and attempts to avoid the pitfalls of underfitting or overfitting.

In an embodiment, evaluation and tuning module 828 integrates data feedback and updates the model. Evaluation and tuning module 828 actively collects feedback from the model’s real-world applications, an indicator of the model’s performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model’s prediction errors, misclassifications, or other performance metrics in live environments.

In an embodiment, feedback integration logic within evaluation and tuning module 828 integrates this feedback using a process of assimilating new data patterns, user interactions, and error trends into the system’s knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 828 employs version control mechanisms to track changes, modifications, and the evolution of the model, facilitating transparency and allowing for rollback if necessary. This continuous learning and adaptation cycle, driven by real-world data and feedback, helps to ensure the model’s ongoing effectiveness, relevance, and accuracy.

In an embodiment, inference module 830 transforms raw data into actionable, precise, and contextually relevant predictions. In addition to processing and applying a trained model to new data, inference module 830 may also include post-processing logic that refines the raw outputs of the model into meaningful insights.

In an embodiment, inference module 830 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 830 transforms the outputs of a trained model into definitive classifications. Inference module 830 employs the underlying model as a tool to generate probabilistic outputs for each potential class. It then engages in an interpretative process to convert these probabilities into concrete class labels.

In an embodiment, when inference module 830 receives the probabilistic outputs from the model, it analyzes these probabilities to determine how they are distributed across some or every potential class. If the highest probability is not significantly greater than the others, inference module 830 may determine that there is ambiguity or interpret this as a lack of confidence displayed by the model.

In an embodiment, inference module 830 uses thresholding techniques for applications where making a definitive decision based on the highest probability might not suffice due to the critical nature of the decision. In such cases, inference module 830 assesses if the highest probability surpasses a certain confidence threshold that is predetermined based on the specific requirements of the application. If the probabilities do not meet this threshold, inference module 830 may flag the result as uncertain or defer the decision to a human expert. Inference module 830 dynamically adjusts the decision thresholds based on the sensitivity and specificity requirements of the application, subject to calibration for balancing the trade-offs between false positives and false negatives.

In accordance with an embodiment, inference module 830 contextualizes the probability distribution against the backdrop of the specific application. This involves a comparative analysis, especially in instances where multiple classes have similar probability scores, to deduce the most plausible classification. In an embodiment, inference module 830 may incorporate additional decision-making rules or contextual information to guide this analysis, ensuring that the classification aligns with the practical and contextual nuances of the application.

In regression models, where the outputs are continuous values, inference module 830 may engage in a detailed scaling process in an embodiment. Outputs, often normalized or standardized during training for optimal model performance, are rescaled back to their original range. This rescaling involves recalibration of the output values using the original data’s statistical parameters, such as mean and standard deviation, ensuring that the predictions are meaningful and comparable to the real-world scales they represent.

In an embodiment, inference module 830 incorporates domain-specific adjustments into its post-processing routine. This involves tailoring the model’s output to align with specific industry knowledge or contextual information. For example, in financial forecasting, inference module 830 may adjust predictions based on current market trends, economic indicators, or recent significant events, ensuring that the outputs are both statistically accurate and practically relevant.

In an embodiment, inference module 830 includes logic to handle uncertainty and ambiguity in the model’s predictions. In cases where inference module 830 outputs a measure of uncertainty, such as in Bayesian inference models, inference module 830 interprets these uncertainty measures by converting probabilistic distributions or confidence intervals into a format that can be easily understood and acted upon. This provides users with both a prediction and an insight into the confidence level of that prediction. In an embodiment, inference module 830 includes mechanisms for involving human oversight or integrating the instance into a feedback loop for subsequent analysis and model refinement.

In an embodiment, inference module 830 formats the final predictions for end-user consumption. Predictions are converted into visualizations, user-friendly reports, or interactive interfaces. In some systems, like recommendation engines, inference module 830 also integrates feedback mechanisms, where user responses to the predictions are used to continually refine and improve the model, creating a dynamic, self-improving system.

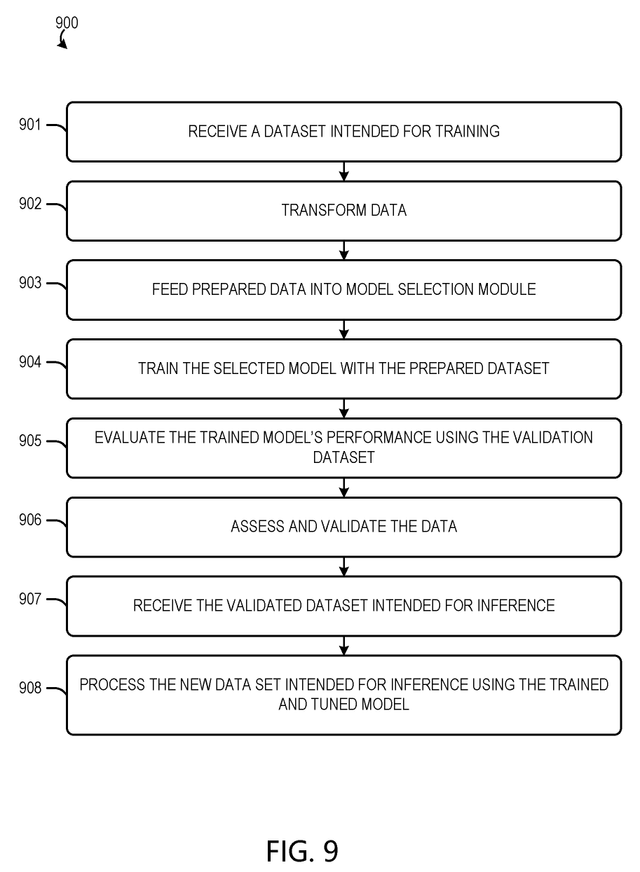

FIG. 9 illustrates the operation 900 of a machine learning engine in one or more embodiments. In an embodiment, input/output module 820 receives a dataset intended for training (Operation 901). This data can originate from diverse sources, like databases or real-time data streams, and in varied formats, such as CSV, JSON, or XML. Input/output module 820 assesses and validates the data, ensuring its integrity by checking for consistency, data ranges, and types.

In an embodiment, training data is passed to data preprocessing module 822. Here, the data undergoes a series of transformations to standardize and clean it, making it suitable for training ML models (Operation 902). This involves normalizing numerical data, encoding categorical variables, and handling missing values through techniques like imputation.

In an embodiment, prepared data from the data preprocessing module 822 is then fed into model selection module 824 (Operation 903). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 826 trains the selected model with the prepared dataset (Operation 904). It implements learning algorithms to adjust the model’s internal parameters, optimizing them to identify patterns and relationships in the training data. Training module 826 also addresses the challenge of overfitting by implementing techniques, like regularization and early stopping, ensuring the model’s generalizability.

In an embodiment, evaluation and tuning module 828 evaluates the trained model’s performance using the validation dataset (Operation 905). Evaluation and tuning module 828 applies various metrics to assess predictive accuracy and generalization capabilities. It then tunes the model by adjusting hyperparameters, and if needed, incorporates feedback from the model’s initial deployments, retraining the model with new data patterns identified from the feedback.

In an embodiment, input/output module 820 receives a dataset intended for inference. Input/output module 820 assesses and validates the data (Operation 906).

In an embodiment, data preprocessing module 822 receives the validated dataset intended for inference (Operation 907). Data preprocessing module 822 ensures that the data format used in training is replicated for the new inference data, maintaining consistency and accuracy for the model’s predictions.

In an embodiment, inference module 830 processes the new data set intended for inference, using the trained and tuned model (Operation 908). It applies the model to this data, generating raw probabilistic outputs for predictions. Inference module 830 then executes a series of post-processing steps on these outputs, such as converting probabilities to class labels in classification tasks or rescaling values in regression tasks. It contextualizes the outputs as per the application’s requirements, handling any uncertainty in predictions and formatting the final outputs for end-user consumption or integration into larger systems.

In an embodiment, machine learning engine API 840 allows for applications to leverage machine learning engine 800. In an embodiment, machine learning engine API 840 may be built on a RESTful architecture and offer stateless interactions over standard HTTP/HTTPS protocols. Machine learning engine API 840 may feature a variety of endpoints, each tailored to a specific function within machine learning engine 800. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 840 is equipped to support SOAP-based interactions. This extension involves defining a WSDL (Web Services Description Language) document that outlines the API’s operations and the structure of request and response messages. In an embodiment, machine learning engine API 840 supports various data formats and communication styles. In an embodiment, machine learning engine API 840 endpoints may handle requests in JSON format or any other suitable format. For example, machine learning engine API 840 may process XML, and it may also be engineered to handle more compact and efficient data formats, such as Protocol Buffers or Avro, for use in bandwidth-limited scenarios.

In an embodiment, machine learning engine API 840 is designed to integrate WebSocket technology for applications necessitating real-time data processing and immediate feedback. This integration enables a continuous, bi-directional communication channel for a dynamic and interactive data exchange between the application and machine learning engine 800.

### Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model’s hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model’s ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 820, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 822 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 824, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 826, when used for large language models, is configured to adjust the model’s parameters through exposure to training data. This process utilizes optimization algorithms, such as stochastic gradient descent, to minimize the difference between the model’s predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model’s performance on new data).

In accordance with one or more embodiments, evaluation and tuning module 828 assesses the performance of large language models using metrics such as perplexity, accuracy, and F1 score, depending on the specific language tasks. Evaluation may involve comparing the model’s output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 830, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model’s parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model’s effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

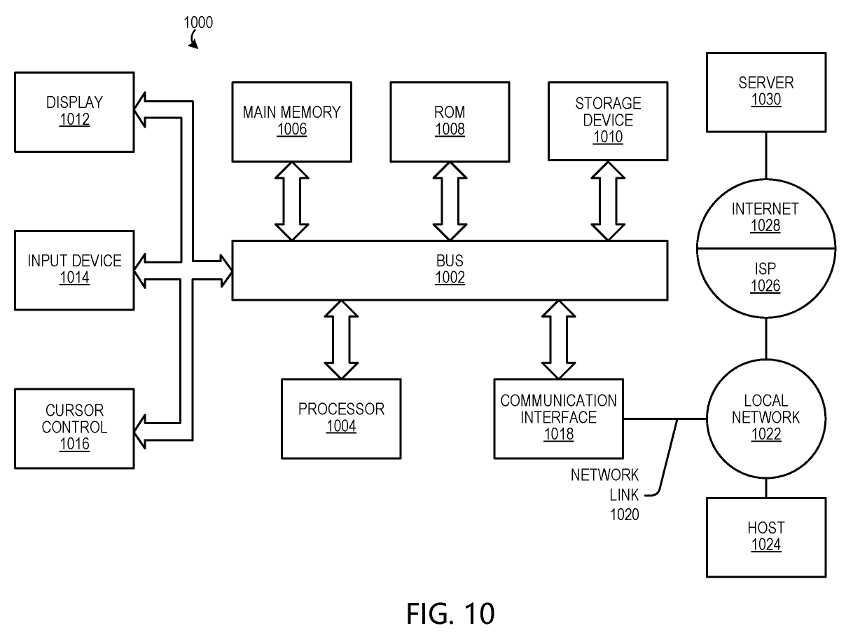

For example, FIG. 10 is a block diagram that illustrates a computer system 1000 upon which aspects of the illustrative embodiments may be implemented. Computer system 1000 includes a bus 1002 or other communication mechanism for communicating information, and a hardware processor 1004 coupled with bus 1002 for processing information. Hardware processor 1004 may be, for example, a general-purpose microprocessor.

Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012 for displaying information to a computer user. An input device 1014, including alphanumeric and other keys, is coupled to bus 1002 for communicating information and command selections to processor 1004. Another type of user input device is cursor control 1016, such as a mouse, a trackball, a touch screen, a track pad, and/or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and/or any other storage media.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem or send the instructions using a network. A receiver, such as a modem, local to computer system 1000 can receive the data and use, for an example, an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented, such as to a wireless local area network (WLAN) or to a cellular network. In any such implementation, communication interface 1018 sends and receives electrical, electromagnetic, radio, optical, and/or other signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world-wide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### Software Overview

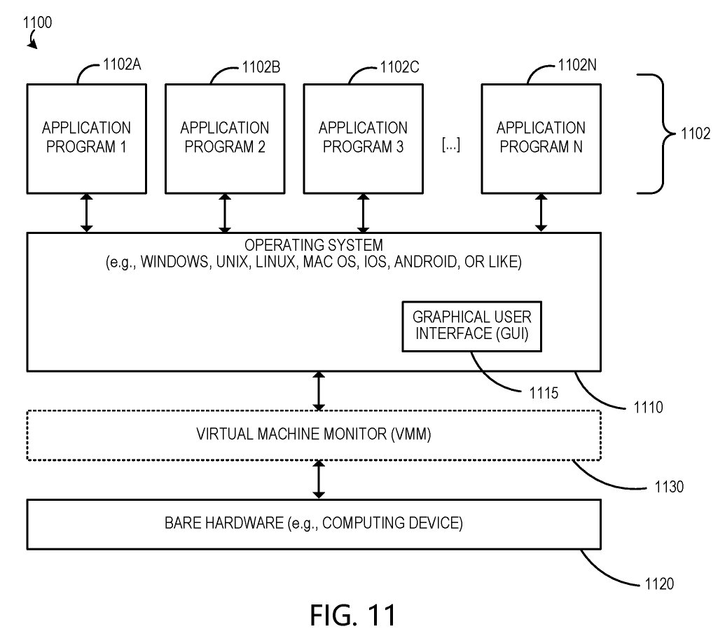

FIG. 11 is a block diagram of a basic software system 1100 that may be employed for controlling the operation of computer system 1000. Software system 1100 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1100 is provided for directing the operation of computer system 1000. Software system 1100, which may be stored in system memory (RAM) 1006 and on fixed storage (e.g., hard disk or flash memory) 1010, includes a kernel or operating system (OS) 1110.

The OS 1110 manages low-level aspects of computer operation, including managing execution of processes, memory allocation, file input and output (I/O), and device I/O. One or more application programs, represented as 1102A, 1102B, 1102C… 1102N, may be “loaded” (e.g., transferred from fixed storage 1010 into memory 1006) for execution by the system 1100. The applications or other software intended for use on computer system 1000 may also be stored as a set of downloadable computer-executable instructions, for example, for downloading and installation from an Internet location (e.g., a Web server, an app store, or other online service).

Software system 1100 includes a graphical user interface (GUI) 1115, for receiving user commands and data in a graphical (e.g., “point-and-click” or “touch gesture”) fashion. These inputs, in turn, may be acted upon by the system 1100 in accordance with instructions from operating system 1110 and/or application(s) 1102. The GUI 1115 also serves to display the results of operation from the OS 1110 and application(s) 1102, whereupon the user may supply additional inputs or terminate the session (e.g., log off).

OS 1110 can execute directly on the bare hardware 1120 (e.g., processor(s) 1004) of computer system 1000. Alternatively, a hypervisor or virtual machine monitor (VMM) 1130 may be interposed between the bare hardware 1120 and the OS 1110. In this configuration, VMM 1130 acts as a software “cushion” or virtualization layer between the OS 1110 and the bare hardware 1120 of the computer system 1000.

VMM 1130 instantiates and runs one or more virtual machine instances (“guest machines”). Each guest machine comprises a “guest” operating system, such as OS 1110, and one or more applications, such as application(s) 1102, designed to execute on the guest operating system. The VMM 1130 presents the guest operating systems with a virtual operating platform and manages the execution of the guest operating systems.

In some instances, the VMM 1130 may allow a guest operating system to run as if it is running on the bare hardware 1120 of computer system 1000 directly. In these instances, the same version of the guest operating system configured to execute on the bare hardware 1120 directly may also execute on VMM 1130 without modification or reconfiguration. In other words, VMM 1130 may provide full hardware and CPU virtualization to a guest operating system in some instances.

In other instances, a guest operating system may be specially designed or configured to execute on VMM 1130 for efficiency. In these instances, the guest operating system is “aware” that it executes on a virtual machine monitor. In other words, VMM 1130 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing data about a plurality of incidents of a particular type,
each of the plurality of incidents having occurred in one or more computer environments,
each of the plurality of incidents being associated with a plurality of features and a plurality of sets of feature values that correspond to the plurality of features,
wherein each set of feature values of the plurality of sets of feature values corresponds to a different time period of a plurality of time periods;
for each set of feature values of the plurality of sets of feature values:
generating a composite value that is based on said set of feature values; and
adding the composite value to a set of composite values;
inputting a set of first aggregated values into a machine-learned model to generate a predicted set of first aggregated values, where the predicted set of first aggregated values is based on the set of composite values and is based on a first time period length that is longer than a length of each of the plurality of time periods;
inputting a set of second aggregated values into the machine-learned model to generate a predicted set of second aggregated values, where the predicted set of second aggregated values is based on the set of composite values and is based on a second time period length that is longer than the first time period length; and
generating an aggregated set of values based on the predicted set of first aggregated values and the predicted set of second aggregated values;
wherein the method is performed by one or more computing devices.

2. The method of claim 1, further comprising:
inputting a set of third aggregated values into the machine-learned model to generate a predicted set of third aggregated values, where the predicted set of third aggregated values is based on the set of composite values and is based on a third time period length that is longer than the length of each of the plurality of time periods and shorter than the first time period length.

3. The method of claim 2, further comprising:
determining a first slope of a first line based on the aggregated set of values;
determining a second slope of a second line based on the predicted set of third aggregated values; and
identifying a particular time period where the first slope is greater than the second slope.

4. The method of claim 2, further comprising identifying a particular time period where a first line representing the aggregated set of values crosses a second line representing the predicted set of third aggregated values.

5. The method of claim 2, further comprising:
generating a first embedding based on text that is associated with the particular type of incident;
generating a second embedding based on text that is associated with a second type of incident that is different than the particular type of incident; and
based on a similarity between the first embedding and the second embedding, using the predicted set of third aggregated values and the aggregated set of values in a prediction for incidents of the second type.

6. The method of claim 1, further comprising:
based on the set of composite values and for each time period of the plurality of time periods:
prior to inputting the set of first aggregated values into the machine-learned model:
generating a first aggregated value based on a first particular time period of the first time period length; and
adding the first aggregated value to the set of first aggregated values; and
prior to inputting the set of second aggregated values into the machine-learned model:
generating a second aggregated value based on a second particular time period of the second time period length; and
adding the second aggregated value to the set of second aggregated values.

7. The method of claim 1, further comprising:
storing data about a second plurality of incidents of a second particular type;
each of the second plurality of incidents being associated with a second plurality of features and a second plurality of sets of feature values that correspond to the second plurality of features,
wherein each set of feature values of the second plurality of sets of feature values corresponds to a different time period of a plurality of first time periods;
for each second set of feature values of the second plurality of sets of feature values:
generating a second composite value that is based on said second set of feature values; and
adding the second composite value to a second set of composite values;
inputting a second set of first aggregated values into the machine-learned model to generate a second predicted set of first aggregated values, where the second predicted set of first aggregated values is based on the second set of composite values and is based on the first time period length;
inputting a second set of second aggregated values into the machine-learned model to generate a second predicted set of second aggregated values, where the second predicted set of second aggregated values is based on the second set of composite values and is based on the second time period length; and
generating a second aggregated set of values based on the second predicted set of first aggregated values and the second predicted set of second aggregated values.

8. The method of claim 1, wherein
the set of first aggregated values is based on a first moving average of the set of composite values over the first time period length; and
the set of second aggregated values is based on a second moving average of the set of composite values over the second time period length.

9. The method of claim 8, wherein generating the aggregated set of values comprises subtracting the second moving average of the set of composite values from the first moving average of the set of composite values.

10. The method of claim 1, wherein the machine-learned model is an LSTM.

11. The method of claim 1, wherein the plurality of features include at least two selected from an incident frequency, an incident impact, an incident consumer impact, an incident blast impact, an incident lifetime, or an incident standard operating procedure success rate.

12. The method of claim 1, wherein for each set of feature values of the plurality of sets of feature values, generating the composite value comprises summing the values in said set of feature values, each value in said set of feature values corresponding to a different feature of the plurality of features.

13. One or more non-transitory storage media storing one or more sequences of instructions which, when executed by one or more computing devices, cause:
storing data about a plurality of incidents of a particular type,
each of the plurality of incidents having occurred in one or more computer environments,
each of the plurality of incidents being associated with a plurality of features and a plurality of sets of feature values that correspond to the plurality of features,
wherein each set of feature values of the plurality of sets of feature values corresponds to a different time period of a plurality of time periods;
for each set of feature values of the plurality of sets of feature values:
generating a composite value that is based on said set of feature values; and
adding the composite value to a set of composite values;
inputting a set of first aggregated values into a machine-learned model to generate a predicted set of first aggregated values, where the predicted set of first aggregated values is based on the set of composite values and is based on a first time period length that is longer than a length of each of the plurality of time periods;
inputting a set of second aggregated values into the machine-learned model to generate a predicted set of second aggregated values, where the predicted set of second aggregated values is based on the set of composite values and is based on a second time period length that is longer than the first time period length; and
generating an aggregated set of values based on the predicted set of first aggregated values and the predicted set of second aggregated values.

14. The one or more non-transitory storage media of claim 13, wherein the instructions, when executed by the one or more computing devices, further cause inputting a set of third aggregated values into the machine-learned model to generate a predicted set of third aggregated values, where the predicted set of third aggregated values is based on the set of composite values and is based on a third time period length that is longer than the length of each of the plurality of time periods and shorter than the first time period length.

15. The one or more non-transitory storage media of claim 13, wherein the instructions, when executed by the one or more computing devices, further cause inputting a set of third aggregated values into the machine-learned model to generate a predicted set of third aggregated values, where the predicted set of third aggregated values is based on the set of composite values and is based on a third time period length that is longer than the length of each of the plurality of time periods and shorter than the first time period length.

16. The one or more non-transitory storage media of claim 15, wherein the instructions, when executed by the one or more computing devices, further cause:
determining a first slope of a first line based on the aggregated set of values;
determining a second slope of a second line based on the predicted set of third aggregated values; and
identifying a particular time period where the first slope is greater than the second slope.

17. The one or more non-transitory storage media of claim 15, wherein the instructions, when executed by the one or more computing devices, further cause identifying a particular time period where a first line representing the aggregated set of values crosses a second line representing the predicted set of third aggregated values.

18. The one or more non-transitory storage media of claim 15, wherein the instructions, when executed by the one or more computing devices, further cause:
generating a first embedding based on text that is associated with the particular type of incident;
generating a second embedding based on text that is associated with a second type of incident that is different than the particular type of incident; and
based on a similarity between the first embedding and the second embedding, using the predicted set of third aggregated values and the aggregated set of values in a prediction for incidents of the second type.

19. The one or more non-transitory storage media of claim 13, wherein the instructions, when executed by the one or more computing devices, further cause:
based on the set of composite values and for each time period of the plurality of time periods:
prior to inputting the set of first aggregated values into the machine-learned model:
generating a first aggregated value based on a first particular time period of the first time period length; and
adding the first aggregated value to the set of first aggregated values; and
prior to inputting the set of second aggregated values into the machine-learned model:
generating a second aggregated value based on a second particular time period of the second time period length; and
adding the second aggregated value to the set of second aggregated values.

20. The one or more non-transitory storage media of claim 13, wherein
the set of first aggregated values is based on a first moving average of the set of composite values over the first time period length; and
the set of second aggregated values is based on a second moving average of the set of composite values over the second time period length.
